(19) United States
(12) Patent Application Publication
(10) Pub. No.: US 2006/0279227 A1
(43) Pub. Date: Dec. 14, 2006

(54) Method for Operating an Organic Light Emitting Component and Organic Light Emitting Component

(75) Inventors: Markus Burghart, Dresden (DE); Jan Birnstock, Dresden (DE); Sven Murano, Dresden (DE)

Correspondence Address: SUTHERLAND ASBILL & BRENNAN LLP, 999 PEACHTREE STREET, N.E., ATLANTA, GA, 30309, US

(73) Assignee: NOVALED AG, Dresden (DE)

(21) Appl. No.: 11/421,649

(22) Filed: Jun. 1, 2006

(30) Foreign Application Priority Data
Jun. 14, 2005 (EP) EP 05 012 736.4

(51) Int. Cl. G09G 3/10

(52) U.S. Cl. 315/169.3

(57) ABSTRACT

The invention relates to a method for operating an organic light emitting component (1), in particular organic light emitting diode (OLED), and an organic light emitting component (1) with an organic layer (1c) comprising a plurality of different emitter materials, which emit light of different colours, and an electrode arrangement (1a, 1b) for applying electric control pulses to the organic layer (1c), the method having the following steps: operating the organic light emitting component (1) with the help of the electric control pulses in a pulsed operating mode with an operating frequency of at least about 25 Hz; at least partially compensating an ageing induced varying colour change of the light emitted from the organic layer (1c) during the course of the pulsed operation by recording at least one operating parameter characterizing the running pulsed operation of the organic light emitting component (1) and for which a dependence relationship to the ageing induced varying colour change is known at least approximately, and by adjusting a pulse height of the electrical control pulses according to the at least one recorded operating parameter and the ageing induced varying colour change; and regulating a predetermined luminance of the light emitted from the organic layer (1c) during the course of the pulsed operation by adjusting a pulse length of the electric control pulses for regulating the predetermined luminance of the light emitted from the organic layer (1c).

The invention relates to a method for operating an organic light emitting component, in particular organic light emitting diode (OLED), and an organic light emitting component.

### BACKGROUND OF THE INVENTION

Organic light emitting diodes have received increased attention in recent years. Also included herein are organic white light emitting diodes. It is generally accepted that this technology has a great potential for possible applications in the field of lighting technology. Meanwhile, organic light emitting diodes achieve performance coefficients in the range of conventional electric light bulbs (Forrest et al., Adv. Mater. 7, 624 (2004)); further improvements are expected. White light emitting OLEDs therefore have the potential to provide an alternative to the lighting technologies currently dominating the market, for example incandescent lamps, halogen lamps, low voltage fluorescent tubes or similar.

Technical improvements are, however, still necessary for a technological breakthrough of white OLEDs in the lighting market. The challenges which to date have not yet been satisfactorily solved include the realisation of highly efficient, white OLEDs with a long lifetime. Lighting technologies corresponding to the current state of the art have an operating lifetime of some hundred to some ten thousand hours. While lifetimes in this order of magnitude could be demonstrated for monochrome OLEDS, in particular red OLEDs, this is not the case for white OLEDs.

Organic light emitting diodes emitting white light by means of a suitable arrangement of a plurality of organic regions which emit light of different colour are limited in regard to their lifetime by the lifetime of the individual emitter systems. If one of the individual colour components loses intensity relative to the other colour portions, the entire emission spectrum shifts in the direction of the other components, leading to the loss of the general impression of a “white” emission. The lifetime of a white light emitting OLED is therefore limited by the lifetime of the individual components. Because of the difference between the lifetimes of the basic colours within organic light emitting components, wherein particularly blue emitter systems, which are essential for white light emission, present short lifetimes, different ageing of the colour components of white OLEDs present a technical problem.

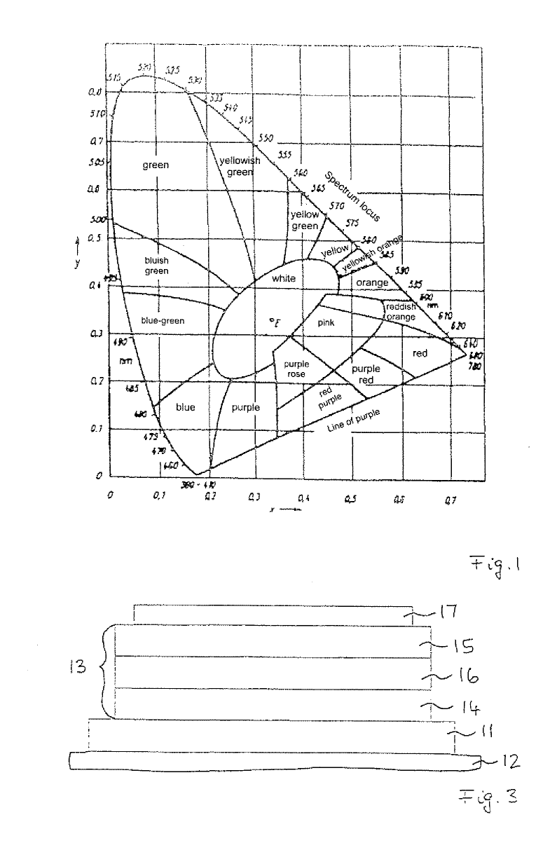

FIG. 1 shows the CIE colour diagram, in which the different colour regions are marked. The white region on the CIE colour diagram is located in the centre in the vicinity of point E, which corresponds to the colour coordinates of sun light.

Typically, organic light emitting diodes are characterized by a voltage dependent emission spectrum, which results in the CIE colour coordinates of the light emission being a function of the diode's luminanoe. This behaviour is particularly pronounced when the OLED comprises a plurality of emitter systems, for example in white light emitting diodes. Although such behaviour may be desirable in certain cases, it is nonetheless worth seeking to uncouple the dependence between emission location and luminance where necessary. This would make it possible to operate a diode with different CIE colour coordinates at constant luminance, or to obtain different luminance for the same colour coordinates.

The different ageing of organic materials emitting light of different colours is manifested, in particular, in the comparatively shorter lifetime of the blue emitter systems in relation to the green and red emitter systems. The different ageing limits the total lifetime of white OLEDs, since a diminishing blue component leads to a colour shift from the white region towards green and/or red.

Furthermore, it is possible that in a white OLED, which is based on the emission of a fluorescent blue emitter as well as of a phosphorescent green and blue emitter, the lifetime of the green phosphorescent emitter has a limiting effect on the total lifetime.

Document EP 1 227 466 A2 discloses a light emitting component wherein a single emitter material is arranged in an organic layer region in such way that the light emitting component emits light of a single colour. A colour display is formed with the help of a plurality of single colour light emitting components In particular, the colour display comprises organic light emitting diodes, which emit red, green and blue light. When operating the single colour organic light emitting diodes, an operating parameter is recorded, in particular the driving voltage. During operation, the driving voltage is corrected in order to maintain a constant driving current for the individual light emitting diodes. This way, a luminance change due to ageing of the diode is corrected for the individual light emitting diode. The correction is carried out individually for each single colour light emitting diode With the help of these individual luminance corrections it is achieved that the relative proportions of light of the individual single colour diodes in the colour display are held substantially constant, thereby maintaining the colour appearance of the colour display.

### SUMMARY OF THE INVENTION

It is the task of the present invention to provide a method for operating an organic light emitting component and an organic light emitting component for which a colour stability of the emitted light is assured throughout the lifetime of the organic light emitting component.

According to the invention this task is solved by a method for operating an organic light emitting component according to the independent claim 1 and an organic light emitting component according to the independent claim 9. Advantageous embodiments of the invention are within the scope of dependent subclaims.

According to one aspect of the invention, a method is provided for operating an organic light emitting component, in particular organic light emitting diode (OLED), with an organic layer comprising a plurality of different emitter materials, which emit light of different colours, so that light of a mixed colour is emitted from the organic layer, and an electrode arrangement for applying electric control pulses to the organic layer, the method having the following steps:
operating the organic light emitting component with the help of the electric control pulses in a pulsed operating mode with an operating frequency of not less than about 25 Hz;
at least partially compensating an ageing induced varying colour change of the mixed colour light emitted from the organic layer during the course of the pulsed operation by recording at least one operating parameter that characterizes the running pulsed operation of the organic light emitting component and for which a dependence relationship to the ageing induced varying colour change is known at least approximately, and by adjusting a pulse height of the electric control pulses according to the at least one recorded operating parameter and the at least approximately known dependence relationship between the at least one operating parameter and the ageing induced varying colour change; and
regulating a predetermined luminance of the mixed colour light emitted from the organic layer during the course of the pulsed operation by adjusting a pulse length of the electric control pulses to regulate the predetermined luminance of the mixed colour light emitted from the organic layer.

According to a further aspect of the invention, there is provided an organic light emitting component, in particular organic light emitting diode (OLED), comprising:
an organic layer comprising a plurality of different emitter materials that emit light of different colours, so that mixed colour light is emitted from the organic layer;
an electrode arrangement electrically connected to the organic layer for supplying the organic layer with electric energy;
a control circuit connected to the electrode arrangement to apply electric control pulses with an operating frequency of no less than about 25 Hz;
a regulating device coupled to the control circuit, with which a pulse height of the electric control pulses is adjustable for regulating a predetermined mixed colour of the light emitted by the organic layer; and
a further regulating device coupled to the control circuit, with which a pulse length of the electric control pulses is adjustable for regulating a predetermined luminance of the mixed colour light emitted by the organic layer.

The ageing of light emitting organic systems is usually described by means of the time period during which, for a given initial operating luminance and for a constant operating current, the organic light emitting component reaches half of the original luminance, the so-called half time. The invention provides the possibility of operating an organic light emitting component with voltage dependent variable colour coordinates of the emitted light in such way that an uncoupling of the control of luminance and colour coordinate of the emitted light is achieved. The consequence of this is that the emitted colour coordinate of the organic light emitting component is variable for a specific luminance, or that the luminance of the organic light emitting component is variable for a specific colour coordinate. Ageing induced colour changes of the emitted light can be compensated in this way.

Pulsed control through voltage or current pulses enables selective adjustment of the colour coordinate of the emitted light as well as simultaneous adjustment of the luminance of the organic light emitting component. Such regulating means enables compensation of the differential colour ageing of an organic light emitting voltage dependent component.

The present invention enables operating an organic light emitting component in such way that individual adjustment of emitted light colour and luminance is possible. Such controllability is particularly desirable for organic light emitting diodes in lighting applications, for example as room lighting or as backlighting in displays. With such selective adjustment of the emitted light colour, the colour coordinate of the emitted light can be adapted individually to the user's wishes. In this manner, the colour temperature is also adjustable in particular for white light emitting organic components.

For the organic light emitting component, provision can be made for the regulating device for adjusting the pulse height of the electric control pulses and for the further regulating device for adjusting the pulse duration of the electric control pulses to be respectively provided with a manual operating element, so that manually adjusting the pulse height/pulse length can be carried out for both characteristic values independently of each other. Alternatively or additionally, a compensation device with recording means for recording of at least one operating parameter may be provided, the operating parameter characterizing the running pulsed operation of the organic light emitting component and for which a dependence relationship to an ageing induced varying colour change is known at least approximately. For this embodiment there is furthermore provided a controlling device coupled to the regulating device and further regulating device, with which the pulse height of the electric pulses is adjustable according to the at least one recorded operating parameter and the at least approximately known dependence relationship between the at least one operating parameter and the ageing induced varying colour change. An automatic regulating means for the pulse height of the electric control pulses is thus realized.

For pulsed operation of an organic light emitting component the luminance of the emitted light results from an averaging of the intensity during a forward pulse (the organic light emitting component is “on”) and of the intensity during a reverse pulse (the organic light emitting component is “off”), also referred to as zero voltage phase. The luminance can thus be increased by lengthening the duration of the forward pulse for a constant period duration. The colour of the emitted light, however, is varied by means of the current during the control pulse, specifically the pulse height. To uncouple the relationships between luminance and colour of the emitted light, the pulse length and the pulse height of the applied control pulses can be modulated. Suitable adjustment of the pulse height enables the regulation of the emission colour, while the pulse length determines the luminance. Individual regulation of the luminance as well as individual regulation of the emission spectrum is thereby possible.

The pulse frequency can hereby be freely selected to a great extent, although it is sensible to adjust it so that the observer gets the impression of a continuous operation of the organic light emitting component. This is particularly the case at high frequencies. The highest possible frequencies are limited by the capacitance of the organic light emitting component, which increases with the area of the organic light emitting component. OLEDs are generally very fast components with a switch-on delay in the range of some nanoseconds.

When using organic emitter systems, which emit light of different colours, in a further development of the invention, it is possible to selectively readjust during operation a colour component of the emitted light, which presents the shortest lifetime of the different emitter systems. Such readjustment is particularly sensible for the blue portion of an organic white light emitting component, since the lifetimes of blue organic emitter systems are generally shorter than those of other emitter systems contributing to white light generation. To reduce the differential ageing of a white light emitting component, when the blue portion of the light emission decreases, this is readjusted by selectively increasing the pulse, while the total luminance of the organic light emitting component can be kept constant by simultaneously shortening the pulse length. This makes it possible to significantly lengthen the total operating lifetime while maintaining the white light emission.

In particular, such regulating means also allows counteracting a differential colour ageing of the individual colour components of the organic light emitting component. Such different ageing is known particularly for white light emitting OLEDs, since, in the case of the organic emitter system, for blue light there is usually first a reduction of the current or quantum efficiency. For OLEDs with a mixture of different colour systems, this results in the spectrum of the emitted light being increasingly depleted of the blue portion for a given luminance and with progressing operation and thus the colour coordinates shifting towards a green-red emission. To counter such ageing, during the pulsed operation of the OLED the emission location is continuously shifted towards the blue region to the extent that the decrease of the blue portion normally takes place throughout the operating time. The emission location, specifically the colour coordinates of the emission are thereby maintained at an overall stable level.

### DESCRIPTION OF PREFERRED EMBODIMENTS OF THE INVENTION

The invention will now be described by way of exemplary embodiments with reference to figures of the drawing in which:

FIG. 1 shows a CIE colour diagram;

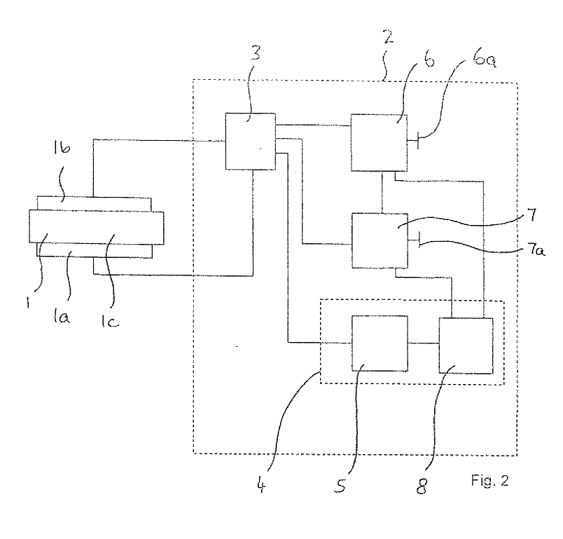

FIG. 2 shows a schematic representation of an arrangement comprising an organic light emitting component and corresponding circuit for operating the organic light emitting component in pulsed operation;

FIG. 3 shows a schematic representation of a layer structure for an organic light emitting component;

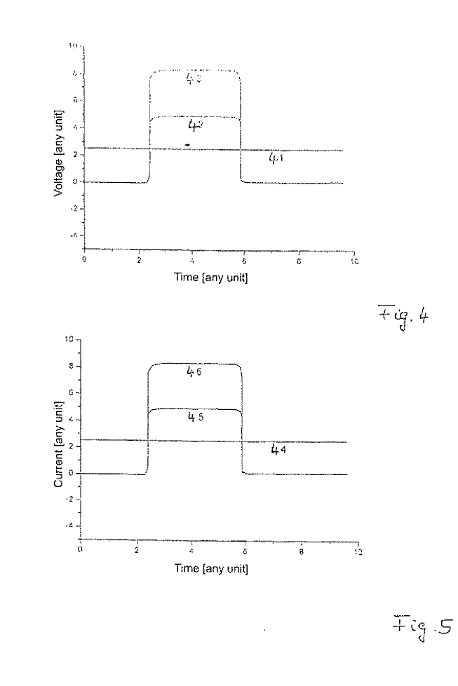

FIG. 4 shows a schematic representation with electric control pulses in the form of voltage pulses of equal pulse duration but different pulse heights;

FIG. 5 shows a schematic representation with electric control pulses in the form of current pulses of different pulse heights and equal pulse duration;

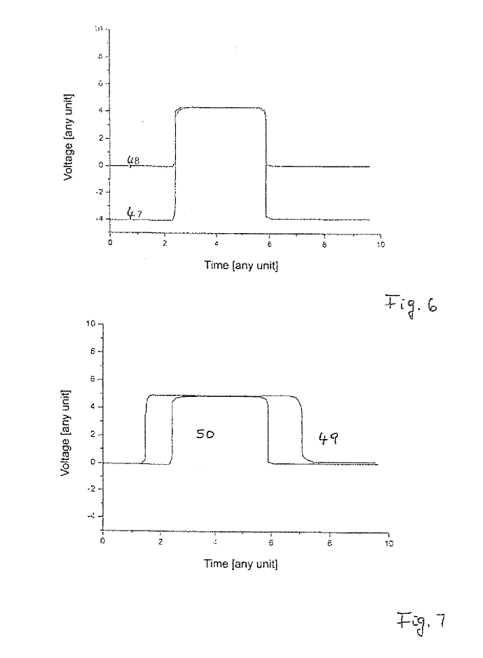

FIG. 6 shows a schematic representation with two voltage pulses of equal pulse length as well as equal pulse height in the positive voltage region;

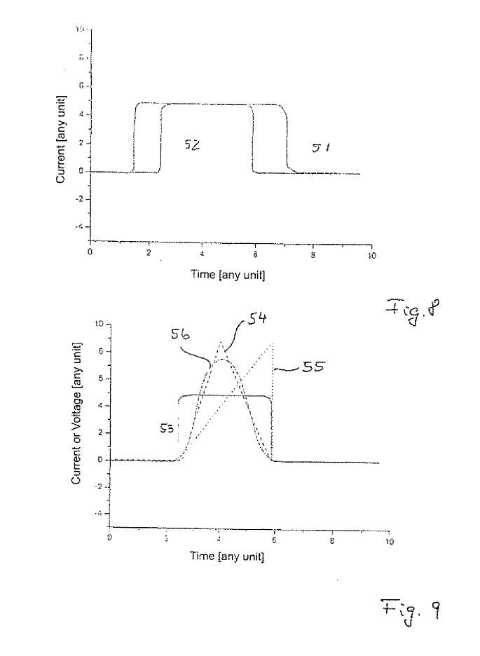

FIG. 7 shows a schematic representation with two voltage pulses of different pulse length as well as equal pulse height;

FIG. 8 shows a schematic representation with two current pulses of different pulse length as well as equal pulse height;

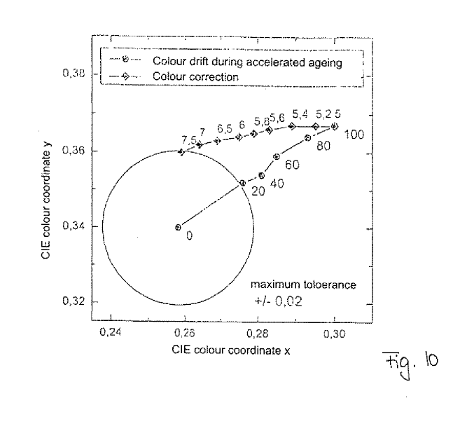

FIG. 9 shows a schematic representation of a plurality of pulse shapes for the electric control pulses; and

FIG. 10 shows a graphical representation of the measured CIE colour coordinates for an organic light emitting component in dependence of ageing and a subsequent correction of the pulse height of the control pulses applied.

FIG. 2 shows a schematic representation of an arrangement of an organic light emitting component 1 with a corresponding circuit 2 for operating the organic light emitting component 1 in a pulsed operating mode. Electrodes 1a, 1b, which serve for applying electric control pulses to an organic region 1c arranged between the two electrodes 1a, 1b, are connected to a control circuit 3. Electric control pulses are applied to the organic light emitting component 1 through the control circuit 3 to excite emitter materials in the organic region 1c so that these emit light. In the organic region 1c there are arranged a plurality of different emitter materials, which each emit light of different colour. In this way, the light emitted from the organic region 1c, which can be white light in particular, is of a mixed colour.

With the help of circuit 2, the organic light emitting component 1 is supplied with electric control pulses, the pulse height and pulse length of which are adjustable independently of each other. For manually adjusting these characteristic values of the electric control pulses, manual operating elements 6a, 7a, for example in form of push button or rotary switches, are provided for a regulating device 6 for adjusting the pulse height and for a further regulating device 7 for adjusting the pulse length. In this way, it is possible to at least partially compensate an ageing induced varying colour change of the mixed colour light emitted from the organic region 1c.

An automatic regulating means is provided in addition to the manual operating elements 6a, 7a or in a different embodiment (not shown) alternative thereto. For this purpose, according to FIG. 2, there are provided a compensation device 4 comprising recording means 5 and a controlling device 8. With the help of the recording means 5 at least one operating parameter can be measured, which characterizes the running pulsed operation of the organic light emitting component 1 and for which a dependence relationship to the ageing induced varying colour change is at least approximately known. It may for instance be known that for one of the emitter materials in the organic region 1c its emissivity decreases with increasing operating duration. The operating duration is measured with recording means 5. With the help of the controlling device 8 the pulse height of the electric control pulses is then regulated through the regulating device 6 according to the at least one recorded operating parameter, namely the operating duration, and the at least approximately known dependence relationship between the operating parameter and the ageing induced varying colour change. In this way, the contribution to the mixed colour light by one of the emitter materials in the organic region 1c can be increased again when it diminishes due to ageing. For instance, the pulse height of the electric control pulses is increased in order to equalize the light contribution of the ageing emitter material in relation to the other emitter materials in the organic region 1c.

The dependence relationship between the measured operating parameter, for example the operating duration or an optical colour analysis of the emitted light, and the ageing induced varying colour change of the emitted light may be known in advance, for instance from calibration measurements on comparable components, or can be determined during the running pulsed operation.

Independently from the regulation of the pulse height, the length of the electric control pulses is adjusted with the further regulation device 7, which takes place manually or automatically by means of controlling device 8. The regulation of the pulse duration hereby essentially affects the luminance of the light emitted from the organic region 1c.

Because of the independent regulation of the pulse height and pulse length it is possible with circuit 2 to maintain the mixed colour light emitted from the organic light emitting component 1 within a predetermined colour range and simultaneously within a predetermined luminance range. In particular luminance changes generated as a result of a readjustment of the pulse height to compensate the ageing induced varying colour change can be balanced out by means of subsequent or simultaneous changing of the pulse duration.

FIG. 3 shows a schematic representation of an exemplary layer structure for the organic light emitting component 1 in FIG. 2 in detail. On an electrode 11, which is formed on a substrate 12, a layer structure 13 of organic materials is applied by means of suitable layer generating methods. According to FIG. 3, two charge carrier transport layers 14, 15 are formed, between which there is an emission layer 16. A further electrode 17 is finally applied on the stack. At least one of the two electrodes 11, 17 is transparent to ensure the release of light generated in the emission layer 16. Moreover, the charge carrier transport layers 14, 15 are usually optimized for transporting one type of charge carriers, i.e. holes or electrons, so that a charge carrier transport layer preferably conducting holes connects to the anode and a charge carrier transport layer preferably conducting electrons connects to the cathode.

FIG. 3 shows an exemplary structure for an OLED. The principles of the invention described below in more detail are, however, not restricted to the structure according to FIG. 3. In particular a larger number of layers may be used, for example in form of a plurality of emission layers or of additional layers for blocking charge carriers or excitons at the interface between charge carrier transport layers and the emission zone or in form of charge carrier injection layers between charge carrier transport layers and the electrodes or between charge carrier transport layers and the emission zone. Moreover, OLED structures with only one or two organic layers are also known, in particular in the field of polymer OLEDs; the invention is also applicable to such OLEDs.

Furthermore, the invention can also be used for light emitting organic components in which a plurality of OLED units is stacked, as long as these are not connected separately to a supply voltage.

A pulsed control of the light emitting organic component is provided, with which an uncoupling of luminance and colour coordinate of the emitted light is achieved. For this it is made use of the fact that OLEDs usually present a dependence of the emission colour on the supply voltage. This is the case particularly for OLEDs presenting an emission over a broad spectrum, particularly for OLEDs presenting an emission in the white region of the spectrum of the CIE colour diagram (see FIG. 1). This dependence of the emission colour on the supply voltage is selectively utilized. To achieve an uncoupling of luminance and chromaticity coordinates of the emission, a control using a pulsed supply voltage is provided.

FIG. 4 shows a schematic representation with electric control pulses in form of voltage pulses 42, 43 of equal pulse duration but different pulse heights. In addition it shows a direct voltage 41.

FIG. 5 shows a schematic representation with electric control pulses in form of current pulses 45, 46 of different pulse height and equal pulse duration. In addition, it shows a direct voltage 44 for comparison. When applied to the organic region with the different emitter materials (see FIGS. 2 and 3) the different pulse heights lead to different emission colours, since for a higher current a correspondingly higher supply voltage is required; furthermore, the luminance values for the emitted light are different for different height of the current pulses.

FIG. 6 shows two voltage pulses 47, 48 of equal pulse length as well as equal pulse height in the positive voltage region; however, the voltage pulse 47 differentiates itself from the voltage pulse 48 in such way that a negative voltage is applied in the switched-off condition of the component, meaning that no positive voltage is applied.

For the uncoupled regulation of colour and luminance of the emitted light, in a preferred operating mode a desired colour of the emitted light is first adjusted through the pulse height. The luminance is subsequently regulated by varying the pulse length. FIG. 7 shows such regulation using as an example two voltage pulses 49, 50, the voltage pulse 50 leading to a lower total luminance of the emitted light due to the smaller pulse length, whereas the colour of the emitted mixed colour light remains the same due to the identical pulse height.

FIG. 8 shows an analogue uncoupling of luminance and colour regulation for the emitted light for two current pulses 51, 52, wherein a control using the current pulse 52 makes the emission of the component appear less bright overall due to the decreased pulse length.

FIG. 9 shows a schematic representation of a plurality of pulse shapes for the electric control pulses compared to a rectangular pulse 53. A triangular pulse 54, a sawtooth pulse 55 and a sinusoidal pulse 56 are shown. Besides a variation of the pulse height and the pulse length, the shape of the control pulses may be varied, which leads to the changing of both the voltage and the flowing current during a control pulse. Apart from the rectangular pulses shown in FIGS. 4 to 8, triangular pulses, sawtooth pulses and sinusoidal pulses are, for example, possible, in principle more complex pulse shapes can be realized as well. By means of different pulse shapes different colours can be generated for the same pulse amplitude and same pulse length for the same resulting luminance of the emitted light. In particular, for a specific colour to be generated there is, as a rule, a pulse shape for which this colour is realized with the least “loading” of the organic light emitting component, i.e. for example, for the lowest pulse height. Selecting such a pulse shape helps increasing the lifetime of the component.

The different pulse shapes can be realized for voltage as well as for current regulated control forms, although there are differences between current and voltage pulses regarding the luminance achieved by means of the pulse. While an OLED emits light already at a small current flow and, under the assumption of a constant current efficiency of the component, which is approximately true for OLEDs in many cases, the luminance is thus proportional to the area under the pulse function, this assumption is not possible for voltage driven components, since OLEDs emit light only after reaching a threshold voltage, which is different for individual OLED structures.

A preferred exemplary embodiment for an organic light emitting component, for which a compensation for differential ageing was realized, will be provided in the following text. This constitutes an OLED with an emitter structure comprising two different emitter materials, namely a blue and orange-red emission layer. In other embodiments three or more emitter layers of different colour may also be provided. OLEDs with a plurality of emitter materials within a layer may also be provided.

The OLED in the exemplary embodiment comprises the following layer structure:
1) Anode: Indium tin oxide (ITO)
2) p-doped hole transport layer: 80 nm MeO-TPD doped with 4 mass % of F4-TCNQ
3) Hole-side intermediate layer: 10 nm Spiro-TAD
4) Orange-red emission layer: 10 nm Spiro-TAD doped with 15 mass of iridium(III) tris(1-phenylisoquinoline)
5) Blue emitter layer: 15 nm 4,4′-bis(9-carbazolyl)-biphenyl doped with 6 mass of iridium(III) bis(2-(4,6-diflurophenyl)pyridinato-N,C2′)picolinate
6) Electron-side intermediate layer: 10 nm bathophenanthroline
7) n-doped electron transport layer: 30 nm bathophenanthroline doped with Cs (molecular ratio of 1:1)
8) Cathode: 100 nm aluminium

At a supply voltage of 5 V, this OLED presents an emission in the white light region of the CIE diagram with the CEE colour coordinates x=0.26/y=0.34 for a luminance of 530 cd/m².

For the purpose of accelerated ageing, this OLED was then operated initially with a current density of 31.5 mA/cm² for 70 minutes and subsequently with a current density of 63 mA/cm² for further 30 minutes. This operating scheme is used to induce an accelerated ageing of the component, since the selected current density is clearly higher than that utilized under normal operating conditions.

During the accelerated ageing of the OLED the colour coordinate of the emission at the original operating voltage of 5 V was determined at regular intervals (see FIG. 10). The result is that the colour coordinates of the emission move away from the original starting point in the CIE colour diagram, with the emission shifting towards the yellow-orange region. After an ageing of 20 minutes, the emission of the component is already beyond the maximum permitted tolerance, which was set to +/−0.02 coordinate points of the colour coordinate in the CIE diagram. At the end of the ageing phase, the emission of the OLED is found at x=0.30/y=0.37 for a supply voltage of 5 V, and is therefore over more than 0.04 coordinate points away from the original emission location.

After completion of the ageing time of 100 minutes, it is now possible to shift the emission of the component again towards the colour coordinate by means of a suitable supply voltage selection. At a supply voltage of 7.5 V, emission is observed at x=0.26/y=0.36, which is now again within the set tolerance limits. The observed luminance of the component is hereby 1150 cd/m² and is therefore slightly over twice as large as the original luminance at 5 V. For an original luminance of 530 cdVm² at a supply voltage of 5 V, a pulse length with a pulse height of 7.5 V is now required under pulsed operation, which is 46% of the original pulse length. A corresponding shortening of the pulse length resulted in the original luminance value being reached again.

The characteristics of the invention disclosed in the above description, recited in the claims and shown in the drawings, may be important for the realisation of the invention in its various embodiments either individually as well as in arbitrary combination.

1. A method for operating an organic light emitting component, in particular organic light emitting diode (OLED), with an organic layer comprising a plurality of different emitter materials, which emit light of different colours, so that light of a mixed colour is emitted from the organic layer, and an electrode arrangement for applying electric control pulses to the organic layer, the method having the following steps:
operating the organic light emitting component with the help of the electric control pulses in a pulsed operating mode with an operating frequency of at least about 25 Hz;
at least partially compensating an ageing induced varying colour change of the mixed colour light emitted from the organic layer during the course of the pulsed operation by recording at least one operating parameter that characterizes the running pulsed operation of the organic light emitting component and for which a dependence relationship to the ageing induced varying colour change is known at least approximately, and by adjusting a pulse height of the electric control pulses according to the at least one recorded operating parameter and the at least approximately known dependence relationship between the at least one operating parameter and the ageing induced varying colour change; and
regulating a predetermined luminance of the mixed colour light emitted from the organic layer during the course of the pulsed operation by adjusting a pulse length of the electric control pulses to regulate the predetermined luminance of the mixed colour light emitted from the organic layer.

2. Method according to claim 1, characterized in that the pulse length of the electric control pulses is adjusted to counteract a luminance change caused by the adjustment of the pulse height of the electric control pulses during the at least partial compensation of the ageing induced varying colour change.

3. Method according to claim 1, characterized in that the light of different colour emitted from the plurality of different emitter materials in the organic layer is mixed to white light.

4. Method according to claim 1, characterized in that the mixed colour light emitted from the organic layer is maintained within a predetermined colour region of the CIE diagram by means of the at least partial compensation of the ageing induced varying colour change.

5. Method according to claim 1, characterized in that a CIE value of the mixed colour light emitted from the organic layer during pulsed operation is recorded as the at least one operating parameter.

6. Method according to claim 1, characterized in that a time value for an operating duration of the pulsed operation is recorded as the at least one operating parameter.

7. Method according to claim 1, characterized in that the electric control pulses are realised as rectangular, triangular, sawtooth or sinusoidal pulses or a combination thereof.

8. Method according to claim 1, characterized in that the electric control pulses are applied as current regulated or voltage regulated control pulses.

9. An organic light emitting component, in particular organic light emitting diode (OLED), comprising:
an organic layer comprising a plurality of different emitter materials emitting light of different colours so that mixed colour light is emitted from the organic layer;
an electrode arrangement electrically connected to the organic layer for supplying the organic layer with electric energy;
a control circuit connected to the electrode arrangement for applying electric control pulses with an operating frequency of at least about 25 Hz;
a regulating device coupled to the control circuit, with which a pulse height of the electric control pulses is adjustable for regulating a predetermined mixed colour of the light emitted by the organic layer; and
a further regulating device coupled to the control circuit, with which a pulse length of the electric control pulses is adjustable for regulating a predetermined luminance of the mixed colour light emitted by the organic layer.

10. Organic light emitting component according to claim 9, characterized in that the regulating device and the further regulating device are each provided with one manual operating element with which the pulse height and pulse length are adjustable.

11. Organic light emitting component according to claim 9, characterized by a compensation device comprising recording means for recording at least one operating parameter characterizing the running pulsed operation of the organic light emitting component and for which a dependence relationship to an ageing induced varying colour change is known at least approximately, and by a controlling device coupled to the regulating device and optionally to the further regulating device, with which the pulse height of the electric control pulses is adjustable according to the at least one recorded operating parameter and the at least approximately known dependence relationship between the at least one operating parameter and the ageing induced varying colour change.

12. Organic light emitting component according to claim 11, characterized in that the control circuit and/or the regulating device and/or the further regulating device and/or the compensation device are arranged in a common circuit.

13. Organic light emitting component according to claim 11, characterized in that the recording means comprise an optical measuring device for measuring optical properties of the mixed colour light emitted from the organic layer.

14. Organic light emitting component according to claim 11, characterized in that the recording means has a time measuring device for measuring an operating duration.

15. Organic light emitting component according to claim 9, characterized in that the organic layer is realized with a plurality of different emitter materials so as to emit white light.

16. Organic light emitting component according to claim 9, characterized in that the organic layer comprises a plurality of layers and the several different emitter materials are distributed over several layers.
